(19) United States
(12) Patent Application Publication
(10) Pub. No.: US 2025/0273188 A1
(43) Pub. Date: Aug. 28, 2025

(54) AIR HORNS AND METHOD OF USE

(71) Applicant: Security Equipment Corporation, Fenton, MO (US)

(72) Inventor: Anthony E. Sprouse, II, Caseyville, IL (US)

(21) Appl. No.: 19/051,552

(22) Filed: Feb. 12, 2025

Related U.S. Application Data
(60) Provisional application No. 63/559,016, filed on Feb. 28, 2024.

(51) Int. Cl. G10K 9/20; G10K 9/04

(52) U.S. Cl. CPC G10K 9/20; G10K 9/04

(57) ABSTRACT

Air horns and methods for their operation. Such an air horn includes a main body having a cavity, a base, an actuator housing, and a diaphragm housing and bell fluidically connected to the cavity and to a channel within the main body. The actuator housing has a wall, a cavity surrounded by the wall, and standoffs within the cavity that define first and second sets of gaps between pairs of the standoffs. An actuator is coupled to the actuator housing so as to have first and second rotational positions. The actuator includes a shaft received in the cavity and standoff guides that individually receive pairs of the standoffs. The standoffs and the standoff guides interact to only permit axial movement of the actuator relative to the actuator housing when the actuator is in the first and second rotational positions and not at any rotational position therebetween.

### CROSS-REFERENCE TO RELATED APPLICATIONS

This application claims the benefit of U.S. Provisional Application No. 63/559,016 filed Feb. 28, 2024, the contents of which are incorporated herein by reference.

### BACKGROUND OF THE INVENTION

The present invention generally relates to air horns for use in combination with a container of a compressed gas. More particularly, the invention relates to air horns that include a lockable push-button actuator that is configured to prevent accidental discharge of compressed gas from a container.

Air horns are generally types of devices that use compressed air or other gas to produce an audible sound, as a nonlimiting example, a sound sufficiently loud to discourage, startle, or frighten an animal. Existing air horns are typically equipped with an actuating mechanism through which air is discharged to produce the sound. However, such actuating mechanisms are often not particularly well configured to prevent being unintentionally actuated, even if the actuating mechanism is in an “off” position.

It would be desirable if air horns were available that provide a more secure means for preventing an accidental discharge and yet easily operated to produce an audible sound when needed.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, to air horns for use with containers containing a compressed gas, and methods for their operation.

According to a nonlimiting aspect, an air horn is provided that is configured to be releasably connected to a container of compressed gas. The air horn includes a main body having a cavity, a channel wall within the cavity, and a channel defined and surrounded by the channel wall. The air horn further has a base having a wall extending into the main body, a diaphragm housing connected a first end of the main body and fluidically connected to the cavity and the channel of the main body, and a bell fluidly connected to the channel of the main body. The base has an inlet port of the air horn defined by the wall, an orifice disposed in the wall to fluidically connect the inlet port with the cavity of the main body, and connecting means for releasably connecting the air horn to a container of compressed gas. An actuator housing has a wall connected to the main body, a cavity surrounded by the wall of the actuator housing, and standoffs within the cavity of the actuator housing that define a first set of gaps between a first pair of the standoffs and a second set of gaps between a second pair of the standoffs. A pin is surrounded by the standoffs and adapted to axially reciprocate within a bore within the main body. An actuator is coupled to the actuator housing so as to have rotational orientations that include a first rotational position and in a second rotational position. The actuator includes a shaft received in the cavity of the actuator housing and standoff guides defined within the shaft that individually receive pairs of the standoffs. The standoffs and the standoff guides interact to only permit axial movement of the actuator relative to the actuator housing when the actuator is in the first rotational position and in the second rotational position and not at any rotational position therebetween. The first rotational position corresponds to an OFF position of the actuator and the second rotational position corresponds to an ON position of the actuator.

Another aspect of the invention is a method of operating an air horn as described above. The method includes releasably connecting the air horn with the connecting means to a container of compressed gas, positioning the actuator in the first rotational position to prevent actuation of the actuator and prevent release of the compressed gas from the container, and rotating the actuator to the second rotational position to permit actuation of the actuator and permit release of the compressed gas from the container.

Technical aspects of air horns as described above preferably include being equipped with an actuator configured to prevent or at least reduce the risk of intentionally activating the air horn when the actuator is in an off position or when a non-axial force is applied to the actuator.

These and other aspects, arrangements, features, and/or technical effects will become apparent upon detailed inspection of the figures and the following description.

### BRIEF DESCRIPTION OF THE DRAWINGS

FIGS. 1 and 2 are perspective side views of an air horn of the present invention mounted to a container of compressed gas.

FIGS. 3 and 4 schematically represent bottom and top perspective views, respectively, of the air horn of FIGS. 1 and 2.

FIG. 5 schematically represents a partially exploded top perspective view of the air horn of FIGS. 1 and 2.

FIG. 6 schematically represents a perspective end view of the air horn of FIGS. 1 and 2 with a diaphragm housing thereof removed.

FIG. 7 schematically represents a partial top perspective view of the air horn of FIGS. 1 and 2 showing an actuator thereof in an OFF position.

FIG. 8 schematically represents a detail of FIG. 7 with the actuator depicted as translucent to reveal internal structures of the actuator and an actuator housing of the air horn.

FIG. 9 schematically represents a partial top perspective view of the air horn of FIGS. 1 and 2 showing the actuator thereof in an ON position.

FIG. 10 schematically represents a detail of FIG. 9 with the actuator depicted as translucent to reveal internal structures of the actuator and the actuator housing.

### DETAILED DESCRIPTION OF THE INVENTION

The intended purpose of the following detailed description of the invention and the phraseology and terminology employed therein is to describe what is shown in the drawings, which include the depiction of and/or relate to one or more nonlimiting embodiments of the invention, and to describe certain but not all aspects of what is depicted in the drawings, including the embodiment(s) depicted in the drawings. The following detailed description also describes certain investigations relating to the embodiment(s) depicted in the drawings, and identifies certain but not all alternatives of the embodiment(s) depicted in the drawings. As nonlimiting examples, the invention encompasses additional or alternative embodiments in which one or more features or aspects shown and/or described as part of a particular embodiment could be eliminated. Therefore, the appended claims, and not the detailed description, are intended to recite particularly point out subject matter regarded to be aspects of the invention, including certain but not necessarily all of the aspects and alternatives described in the detailed description.

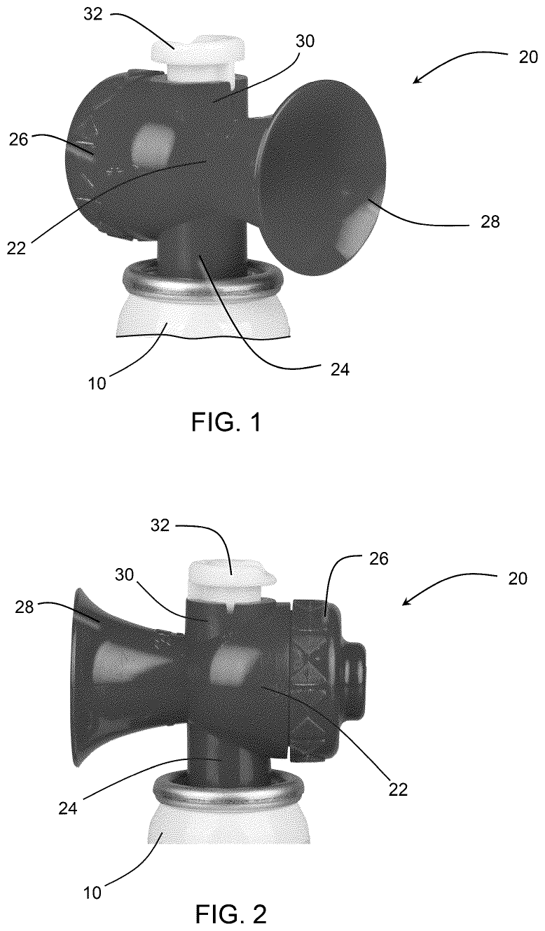

FIGS. 1 and 2 represent an air horn 20 of the present invention connected to a canister 10 that contains a compressed gas, as a nonlimiting example, air. The air horn 20 is operable to cause compressed gas from the canister 10 to pass through the air horn 20 to generate an audible sound. In some cases the audible sound may be at a sufficiently high decibel to be effect to discourage, startle, or frighten an animal or individual that may pose a threat to the user of the air horn 20, though it is also within the scope of the invention that the audible sound could be at lower decibels and/or used for other purposes, as a nonlimiting example, as a signaling device on a boat or outdoors, which can be useful in the event of an emergency. Though the term “air” will be used herein to refer to the device represented in the drawings, use of this term is a matter of convenience and it should be understood that the air horn 20 is not limited to using air to produce an audible sound.

FIGS. 1 and 2 represent the air horn 20 as generally including a main body 22, a base 24 extending downward from the main body 22, a diaphragm housing 26 secured to a first side of the main body 22, a bell 28 disposed at a second side of the main body 22 opposite the diaphragm housing 26, an actuator housing 30 extending upward from the main body 22 opposite the base 24, and an actuator 32 mounted to the actuator housing 30. The base 24, bell 28, and actuator housing 30 may be integrally formed with the main body 22, such as by injection molding, or formed separately and assembled together. As known in the art, the diaphragm housing 26 contains a diaphragm (not shown) that converts the energy of the compressed gas flowing from the canister 10 into sound waves that are emitted through the bell 28. As shown in FIGS. 1 and 2, the bell 28 is in the shape of a catenoid bell.

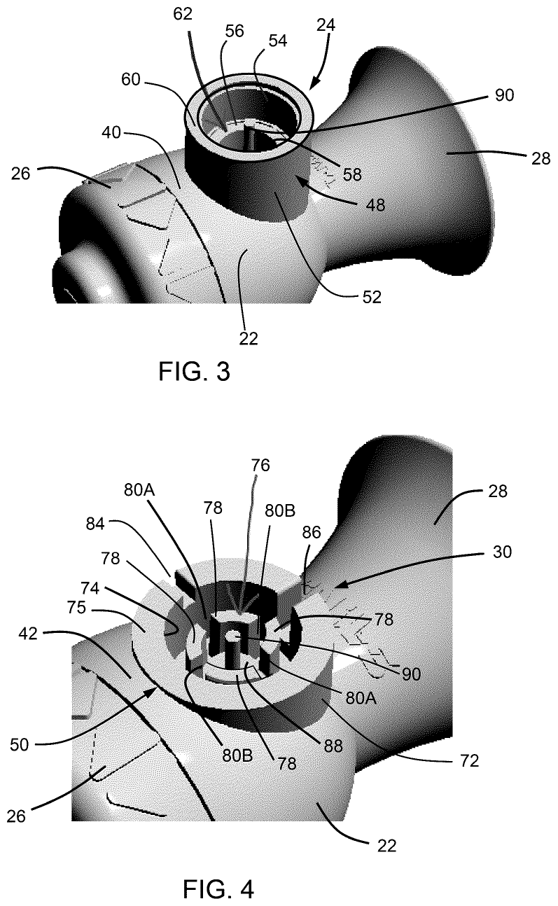

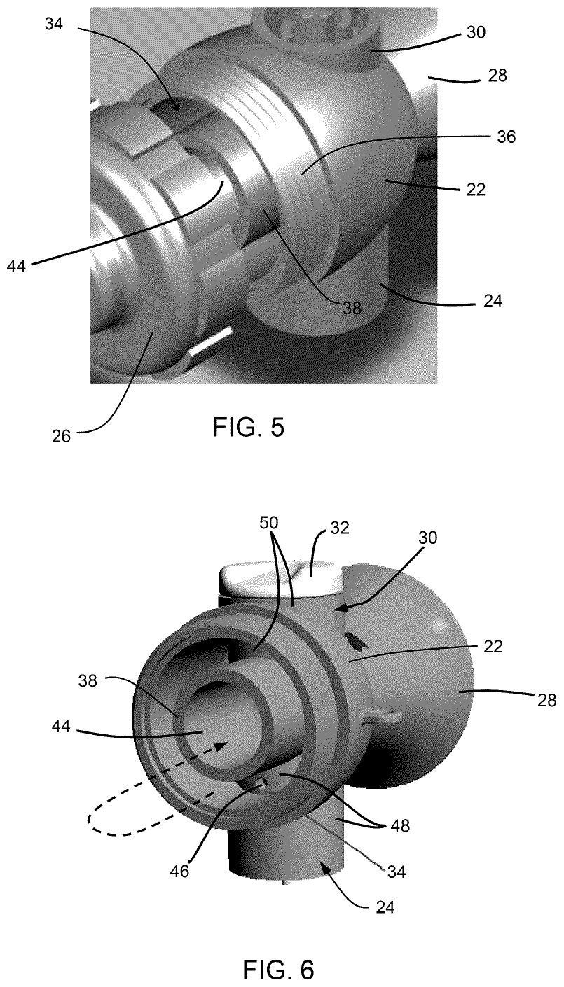

FIG. 3 schematically represents a lower side 40 of the air horn 20 and the base 24 protruding from the main body 22. The canister 10 is removed to expose an interior cavity 62 of the base 24. As shown, the base 24 has an annular or tubular-shaped wall 48 that defines an outer sidewall 52 at the exterior of the base 24, an inner sidewall 54 within the cavity 62 of the base 24, and a lip or rim 60 therebetween at a distal end of the base 24. Connection means (not shown) such as threads may be provided within the inner sidewall 54 for connecting the air horn 20 to the canister 10. A boss 56 within the cavity 62 defines a surface that is substantially planar and parallel to the rim 60 of the base 24. The boss 56 is located within the cavity 62 to provide a bearing surface between the base 24 and the canister 10, for example, a neck of the canister 10 that may be equipped with male threads for threading into female threads provided on the inner sidewall 54 of the base 24. The boss 56 acts as a stop when threading or otherwise inserting a complementary portion of the canister 10 into the base 24 of the air horn 20, thereby preventing over-threading as well as creating an air-tight seal between the air horn 20 and canister 10. The boss 56 surrounds an inlet port 58 located within the cavity 62. The inlet port 58 is configured to provide a flow path for the compressed gas exiting the canister 10 into an internal cavity 34 of the main body 22 (FIGS. 5 and 6).

FIG. 4 schematically represents an upper side 42 of the air horn 20 and the actuator housing 30 protruding from the main body 22. The actuator 32 is removed to expose an interior cavity 76 of the actuator housing 30. The actuator housing 30 has an annular or tubular-shaped wall 50 that defines an outer sidewall 72 at the exterior of the actuator housing 30, an inner sidewall 74 that surrounds the cavity 76, and a lip or rim 75 therebetween at a distal end of the actuator housing 30. The actuator housing 30 includes a first slot 84 and a second slot 86 that are defined in the rim 75 and extend axially into the wall 50. The second slot 86 axially extends a distance from the rim 75 into the wall 50 that is greater than the distance that the first slot 84 axially extends from the rim 75 into the wall 50. The first slot 84 is located in the rim 75 at a first rotational position corresponding to an OFF position of the actuator 32, whereas the second slot 86 is located in the rim 75 at a second rotational position corresponding to an ON position of the actuator 32. As depicted, the slots 84 and 86 and the ON and OFF positions defined thereby are approximately ninety degrees apart from each other, though other angular positions are foreseeable.

Located within the cavity 76 are standoffs 78 that extend up through the cavity 76. As depicted, four standoffs 78 are provided to form an interrupted (discontinuous) peripheral wall that surrounds an annular-shaped recess 88 and a pin 90 that is centrally located within the recess 88. As discussed below, the pin 90 is adapted to axially reciprocate within a bore 98 within the main body 22 (FIG. 10) for the purpose of interacting with a valve assembly (not shown) conventionally provided on canisters of the type represented in FIGS. 1 and 2, such that translation of the pin 90 toward the canister 10 and into engagement with the valve assembly of the canister 10 releases pressurized gas from the canister 10. The standoffs 78 have arcuate cross-sections so as to have a concave surface facing the pin 90 and a convex surface facing away from the pin 90. First and second sets of gaps 80A and 80B are defined by and between the standoffs 78. The first set of gaps 80A are disposed diametrically opposite each other, and the second set of gaps 80B are disposed diametrically opposite each other and angularly about ninety degrees offset from the first set of gaps 80A. As more fully described below, the actuator housing 30 and its standoffs 78 and slots 84 and 86 are configured to prevent unintentional actuation of the actuator 32, thereby preventing the air horn 20 from producing an audible sound when the actuator 32 is intentionally actuated.

FIGS. 5 and 6 schematically depict the main body 22 of the air horn 20 and internal components thereof. Referring to FIG. 5, threads 36 are formed on a portion of the main body 22 to allow the diaphragm housing 26 to be threadably attached to the main body 22. As can be seen in FIGS. 5 and 6, a channel wall 38 is disposed within the cavity 34 of the main body 22. As depicted, the channel wall 38 has an annular or tubular shape that surrounds and defines a channel 44 that is fluidically connected to the bell 28, thereby allowing air to flow through the channel 44 and into the bell 28. Referring to FIG. 6, the tubular-shaped wall 48 of the base 24 is shown as extending into the cavity 34 of the main body 22 so as to be fluidically connected to the cavity 34 of the main body 22. An orifice 46 is formed in and through the wall 48 of the base 24 within the cavity 34 so as to fluidically connect the inlet port 58 of the base 24 to the cavity 34 of the main body 22, such that compressed gas entering the inlet port 58 of the base 24 from the container 10 flows into the cavity 34. Testing has indicated that the physical relationship of the orifice 46 with the catenoid shape of the bell 28 can be tailored to result in a higher decibel level of sound as compared to an air horn utilizing the catenoid shape of the bell 28 alone or a bell with a conical shape. As represented by the broken arrow in FIG. 6, the compressed gas that enters the cavity 34 flows through the diaphragm housing 26 (not shown) before entering the channel 44.

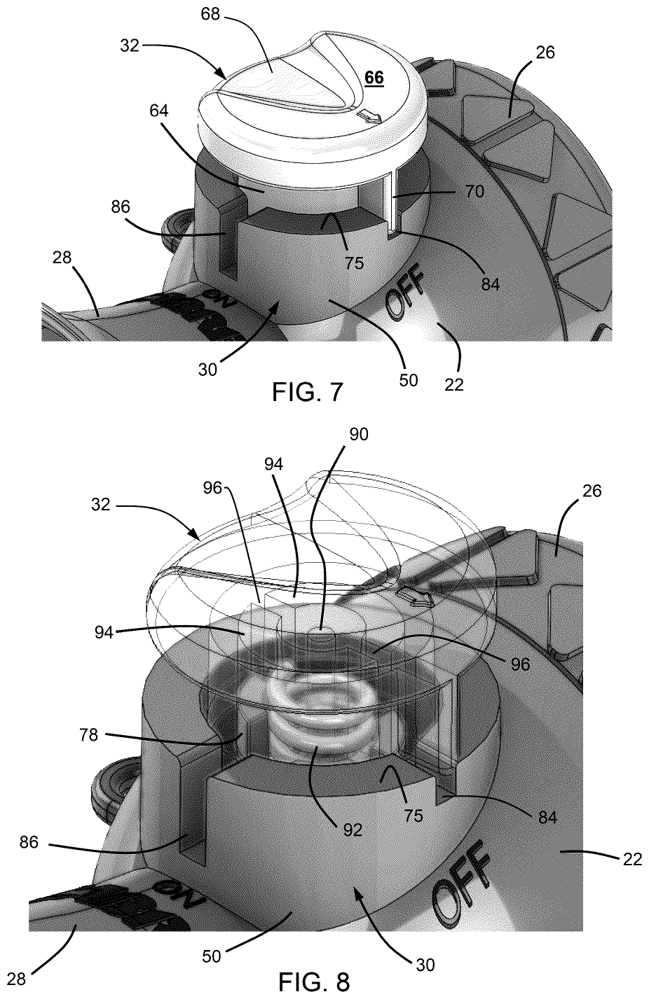

FIGS. 7 and 8 schematically depict detailed views of the actuator housing 30 and actuator 32 of the air horn 20. As shown in FIG. 7, the actuator 32 includes a tubular-shaped shaft 64 with a head 66 at an upper end thereof. The shaft 64 extends into the cavity 76 of the actuator housing 30 and is sized to snugly fit within the inner sidewall 74 of the actuator housing 32, but still able to axially reciprocate within the cavity 76 of the actuator housing 32. The shaft 64 includes a locking feature 70 that extends radially outward from the shaft 64 and axially extends along a length of the shaft 64. In FIG. 7, the locking feature 70 is shown as received in the first slot 84 in the wall 50 of the actuator housing 30. As discussed below, the actuator 32 is able to be rotated so that the locking feature 70 is aligned with and receivable within the second slot 86 in the wall 50, thereby repositioning the actuator 32 from the OFF position to the ON position. The head 66 includes a finger recess 68 that is configured as a depression in the head 66 and sized to receive a finger of a user to provide a tactile indication to the user that their finger is properly positioned on the actuator 32. The head 66 may also include indicia, such as the arrow shown, to visually indicate the location of the locking feature 70 on the actuator 32.

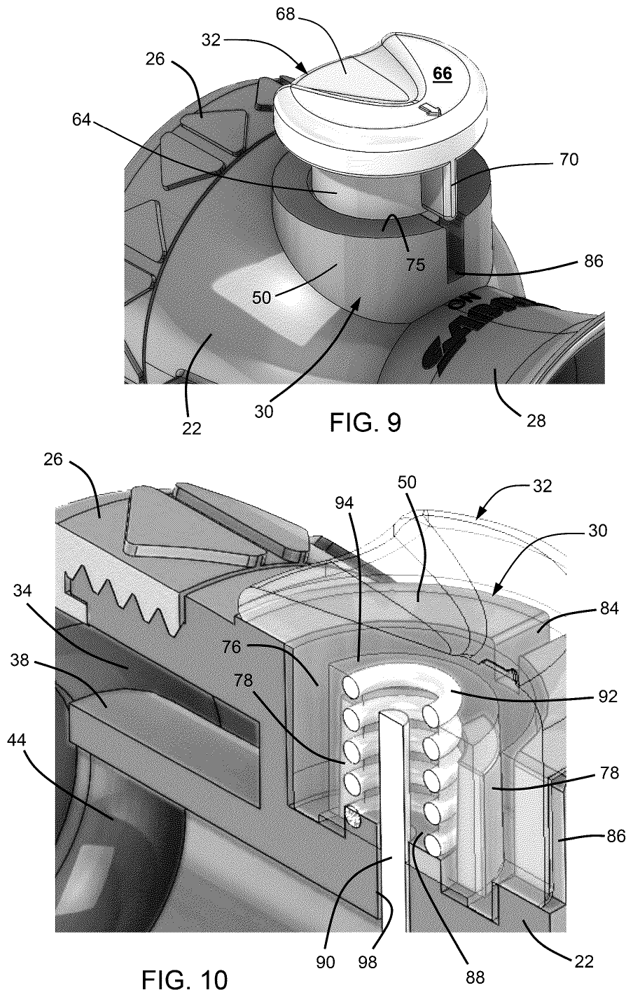

Referring to FIG. 8, the actuator 32 is depicted as translucent in order to reveal internal structures of the actuator 32, including standoff guides 94 that axially extend within the shaft 64 of the actuator 32 from the head 66 of the actuator 32. The standoff guides 94 are represented as two C-shaped bores separated by studs 96 therebetween that extend approximately the length of the shaft 64. Each of the standoff guides 94 is configured to accept two of the standoffs 78 within the cavity 76 of the actuator housing 30, and the studs 96 are configured to reside within either the first or second set of gaps 80A or 80B defined by and between the standoffs 78, depending on the rotational orientation of the actuator 32. FIGS. 7 and 8 schematically depict the instance where the actuator 32 is placed in the OFF position. In this instance, the studs 96 reside in the first set of gaps 80A and the locking feature 70 resides within the first slot 84 in the wall 50 of the actuator housing 30. In this configuration, the actuator 32 is unable to be depressed by a user due to the shallower depth of the first slot 84 relative to the rim 75 of the wall 50, thereby preventing the translation of the pin 90 and unintentionally sounding the air horn 10. However, by rotating the actuator 32 ninety degrees so that the locking feature 70 is aligned with the deeper second slot 86 as shown in FIG. 9, the actuator 32 is able to be depressed by a user to translate the pin 90 and release the compressed gas from the canister 10, thereby generating sound with the air horn 20.

FIG. 8 further represents a spring 92 disposed within the recess 88 surrounded by the standoffs 78 so that the spring 92 is disposed within the cavity 76 of the actuator housing 30, surrounds the pin 90, and is surrounded by the standoffs 78. The spring 92 is coupled to the actuator 32 and to the cavity 76 so as to be operable to retain the locking feature 70 of the actuator 32 in an angular position aligned with the first slot 84, but allows the actuator 32 to be axially raised and rotated so that the locking feature 70 can be rotated to an angular position that aligns the locking feature 70 with the second slot 86, as represented in FIGS. 9 and 10.

FIG. 10 depicts the bore 98 through which the pin 90 extends through the channel 44 surrounded by the channel wall 38 and into the inlet port 58 of the base 24 as shown in FIG. 3, so that the pin 90 is able to interact with the valve assembly of the canister 10. As with FIG. 9, FIG. 10 depicts an instance in which the actuator 32 has been placed in the ON position so that the locking feature 70 is aligned with the deeper second slot 86 in the wall 50 of the actuator housing 30 to enable the actuator 32 to be depressed to actuator the air horn 20. In this rotational position, the studs 96 (not shown in FIG. 10) reside in the second set of gaps 80B, and the actuator 32 is able to compress the spring 92 and translate the pin 90 toward the canister 10 and into engagement with the valve assembly (not shown) of the canister 10 to release pressurized gas from the canister 10, which then flows into the channel 44, through the diaphragm housing 26, and finally through the cavity 34 of the main body 22 before exiting through the bell 28. When the actuator 32 is released, the spring 92 returns the actuator 32 to a neutral position in which the pin 90 disengages the valve assembly of the canister 10 to terminate the release of pressurized gas from the canister 10.

The interaction between the standoffs 78 and the standoff guides 94 as well as the studs 96 and the gaps 80A and 80B function to prevent the actuator 32 from being unintentionally actuated and sounding the air horn 20 in at least two ways. First, the interactions between the standoffs 78 and the standoff guides 94 and the studs 96 and the gaps 80A and 80B only allow the actuator 32 axial movement when in the ON or OFF positions and not at any point rotationally therebetween. Second, the mating interaction of the standoffs 78 with the standoffs guides 94 function to preclude the actuator 32 from moving in any direction other than axially within the actuator housing 32. This single axial movement eliminates the possibility of the actuator 32 engaging the pin 90 and sounding the air horn 20 when a force is applied to the actuator 32 in a direction other than vertical, i.e., along the axis of the actuator 32.

As previously noted above, though the foregoing detailed description describes certain aspects of one or more particular embodiments of the invention, alternatives could be adopted by one skilled in the art. For example, the door finishing system and its components could differ in appearance and construction from the embodiments described herein and shown in the drawings, functions of certain components of the door finishing system could be performed by components of different construction but capable of a similar (though not necessarily equivalent) function, and various materials could be used in the fabrication of the door finishing system and/or its components. As such, and again as was previously noted, it should be understood that the invention is not necessarily limited to any particular embodiment described herein or illustrated in the drawings.

1. An air horn comprising:
a main body having a cavity, a channel wall within the cavity, and a channel defined and surrounded by the channel wall;
a base having a wall extending into the main body, an inlet port of the air horn defined by the wall, an orifice disposed in the wall to fluidically connect the inlet port with the cavity of the main body, and connecting means for releasably connecting the air horn to a container of compressed gas;
a diaphragm housing connected a first end of the main body, the diaphragm housing being fluidically connected to the cavity and the channel of the main body;
a bell fluidly connected to the channel of the main body;
an actuator housing having a wall connected to the main body, a cavity surrounded by the wall of the actuator housing, standoffs within the cavity of the actuator housing that define a first set of gaps between a first pair of the standoffs and a second set of gaps between a second pair of the standoffs;
a pin surrounded by the standoffs and adapted to axially reciprocate within a bore within the main body; and
an actuator coupled to the actuator housing so as to have rotational orientations that include a first rotational position and in a second rotational position, the actuator comprising a shaft received in the cavity of the actuator housing and standoff guides defined within the shaft that individually receive pairs of the standoffs, the standoffs and the standoff guides interacting to only permit axial movement of the actuator relative to the actuator housing when the actuator is in the first rotational position and in the second rotational position and not at any rotational position therebetween, the first rotational position corresponding to an OFF position of the actuator and the second rotational position corresponding to an ON position of the actuator.

2. The air horn of claim 1, wherein the standoff guides comprise two C-shaped bores separated by studs therebetween, the studs being configured to be able to be selectively received within the first set of gaps or within the second set of gaps, depending on the rotational orientation of the actuator.

3. The air horn of claim 1, further comprising:
first and second slots axially extending in the wall of the actuator housing from a rim of the wall, the second slot axially extending a distance from the rim into the wall that is greater than a distance that the first slot axially extends from the rim into the wall, the first slot being located in the rim at the first rotational position and the second slot being located in the rim at the second rotational position; and
a locking feature that extends radially outward from the shaft of the actuator and axially extends along a length of the shaft, the locking feature being selectively receivable in the first and second slots by rotating the actuator.

4. The air horn of claim 3, further comprising a spring disposed in a recess surrounded by the standoffs, the spring being coupled to the actuator and to the cavity of the actuator housing so as to be operable to retain the locking feature in a first angular position aligned with the first slot, and allow the actuator to be axially raised and rotated so that the locking feature is in a second angular position that aligns the locking feature with the second slot.

5. The air horn of claim 1, wherein the bell has a catenoid shape.

6. A method of operating the air horn of claim 1, the method comprising:
releasably connecting the air horn with the connecting means to a container of compressed gas;
positioning the actuator in the first rotational position to prevent actuation of the actuator and prevent release of the compressed gas from the container; and
rotating the actuator to the second rotational position to permit actuation of the actuator and permit release of the compressed gas from the container.
